(19) United States
(12) Patent Application Publication
(10) Pub. No.: US 2008/0217796 A1
(43) Pub. Date: Sep. 11, 2008

(54) Method for Manufacturing a Component Having a Three-Dimensional Structure in a Surface Region and a Ceramic Component

(75) Inventors: Michel Paul Barbara Van Bruggen, Eindhoven (NL); Marcus Antonius Verschuuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/064,634

(22) PCT Filed: Aug. 14, 2006
(86) PCT No.: PCT/IB2006/052800

§ 371 Date: Feb. 25, 2008

(30) Foreign Application Priority Data
Aug. 23, 2005 (EP) 05107706.3

(51) Int. Cl. B29D 11/00

(52) U.S. Cl. 264/1.9

(57) ABSTRACT

A method of manufacturing a component having a three-dimensional structure in a surface region, includes:—a step of forming a substantially solid layer (13) of material, which step comprises the steps of applying a substantially fluid composition over a surface, and—a step of removing an intermediate composition (12), impervious to at least a component of the substantially fluid composition and occupying at least part of the three-dimensional structure when the substantially fluid composition has at least partially set. The step of forming the substantially solid layer (13) of material is preceded by the steps of—providing a structure including recessed parts (5 to 7) on a surface of a substantially solid further layer (3), and—applying the intermediate composition (12) so as at least partially to fill at least the recessed parts (5 to 7) of the structure on the surface of the substantially solid further layer (3).

The invention relates to a method for manufacturing a component having a three-dimensional structure in a surface region, including:

a step of forming a substantially solid layer of material, which step comprises the steps of applying a substantially fluid composition over a surface, and

a step of removing an intermediate composition, impervious to at least a component of the substantially fluid composition and occupying at least part of the three-dimensional structure when the substantially fluid composition has at least partially set.

The invention also relates to the application of such a method. The invention also relates to a ceramic component, obtainable by means of such a method.

An example of such a method is known. US 2003/0148401 discloses methods for preparing substrates having a high surface area for use in a micro-array device. In an embodiment, there is a substrate having a high surface area comprising a solid substrate and a layer of a coating on a surface of the substrate comprising an inorganic oxide and a plurality of micro-channels, in which the micro-channels are formed from a removable fibrous template. In an exemplary embodiment, the coating layer is formed by mixing and/or reacting the removable fibrous template with the precursor of the inorganic coating. This formulation is deposited by a wet chemical method on the surface of a substrate by, for example, a sol-gel process, and then the coated surface is dried under ambient conditions to remove the carrier solvent. The coated surface is heated to decompose the precursor leading to formation of the inorganic oxide and to burn off the removable fibrous template leading to the formation of the micro-channels.

A problem of the known method is that it does not allow accurate positioning of structure parts in the plane of the substrate. The fibers of the fibrous template cannot be positioned accurately.

It is an object of the invention to provide a method, an application of the method and an object of the kind defined above, which enable a relatively accurate positioning of a structure in the surface region.

This object is achieved by means of the method according to the invention, which is characterized in that the step of forming the substantially solid layer of material is preceded by the steps of

providing a structure including recessed parts on a surface of a substantially solid further layer, and

applying the intermediate composition so as at least partially to fill at least the recessed parts of the structure on the surface of the substantially solid further layer.

Because the structure including recessed parts is provided on a surface of a substantially solid further layer, its position in the plane of the layer can be controlled more accurately. This is due to increased accessibility. Moreover, the position in the plane is fixed, as the further layer is substantially solid. Because the intermediate composition at least partially fills the recessed parts, and because it is impervious to the substantially fluid composition, the shapes of the recessed parts are preserved when covered. The layered build-up further has the advantage of allowing use of a relatively wide range of surface treatment methods to define the shape of the structure in the plane of the layers.

In an embodiment, the step of providing the structure on the surface of the further layer includes the step of impressing a stamp including a negative imprint of at least part of the structure on a deformable precursor of the further layer, in which the deformable precursor of the further layer is processed so as to allow the structure to be preserved when the stamp is withdrawn.

This has the effect of providing a structure with good surface properties, requiring little or no machining to achieve a desired grade of finishing. Where no machining is applied, the shapes of the structure features can be more intricate.

In an embodiment, the step of forming the substantially solid layer of material includes the step of impressing a stamp, including a negative imprint of at least part of a structure, on a deformable precursor of the substantially solid layer, and setting the substantially fluid composition to an extent sufficient to enable the structure to be preserved when the stamp is withdrawn.

This enables a wider range of contours in the direction perpendicular to the surface of the layer stack. In particular a certain degree of tapering of recesses in the surface in the direction from the further layer to the substantially solid layer provided over it is attainable. This embodiment also allows for the formation of channels in the two layers that cross each other, but do not communicate with one another.

Variants of any of the latter two embodiments, include impressing a stamp comprising an elastic material, the negative imprint being provided in the elastic material.

These variants ensure good release of the stamp from the deformable material in which it leaves indentations. In particular, the stamp can be withdrawn with substantially no deformation, allowing for repeated use of the stamp.

In a variant, the deformable precursor is provided in the form of a gel. This variant has the advantage that is relatively easy to provide a level and homogeneous layer.

A variant includes providing the deformable precursor by applying a layer of a gelling suspension and triggering the gelling after application of the layer. This variant makes it even easier to provide a layer with a level surface.

In an embodiment, at least one of the substantially fluid composition and a substantially fluid precursor of the substantially solid further layer includes a suspension of particles, in which the method includes the step of removing material in which the particles are suspended after the step of forming a substantially solid layer of material. This has the effect of making it relatively easy to provide a layer in which a structure can be provided with a stamp where the material of the finished object is mainly comprised of a material that does not flow easily under the conditions prevailing on manufacture.

In an embodiment, at least one of the substantially solid layer of material and the substantially solid further layer comprises particles susceptible to sintering, and the method includes the step of sintering the object comprising the substantially solid layer of material.

This has the effect of consolidating the layers, solidifying the stack of layers and fixing the shape of the three-dimensional structure.

In an embodiment, the step of removing the intermediate composition includes subjecting the object comprising the substantially solid layer of material to a heat treatment.

This has the effect that direct access to interstices in the three-dimensional structure is not required. Therefore a wider range of shapes, including hollow parts, is attainable.

According to another aspect of the invention, the method according to the invention is applied in the manufacture of a ceramic component, preferably a ceramic optical component having a reflective and/or refractive structure.

Thus, the method opens up a wider range of accurately provided structures in surface regions of objects having the desirable properties of ceramic objects. These include low thermal expansion coefficients, high thermal stability, high refractive indices, dielectric properties and relatively good stability under high Ultra Violet (UV) fluxes. Accurate positioning and dimensioning of three-dimensional structures on a scale approaching that of optical wavelengths is made possible.

According to another aspect, the invention provides a ceramic component, obtainable by means of a method according to the invention.

Such an object is in itself novel, in that it exhibits a layered build-up near its surface. The structure including recessed parts terminates at a boundary between layers.

The invention will now be explained in further detail with reference to the accompanying drawings, in which:

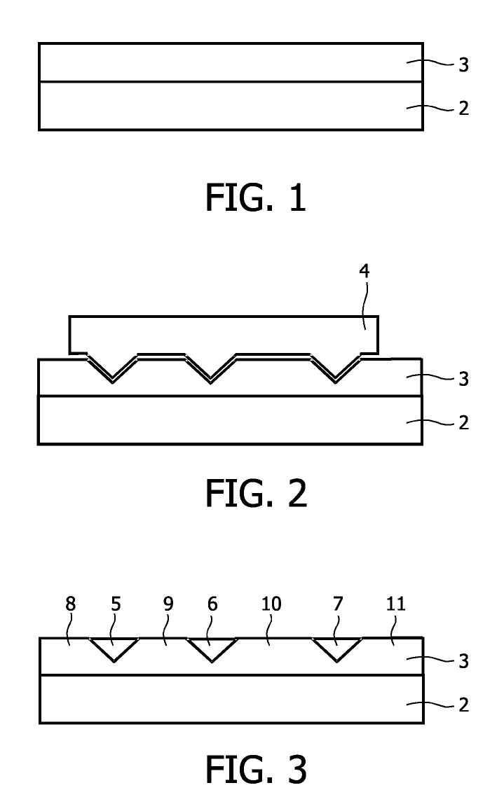

FIG. 1 shows the application of a precursor to a first substantially solid layer of material on a substrate;

FIG. 2 shows the formation of a structure in the surface of the precursor to the first layer;

FIG. 3 shows the structure preserved in the first layer;

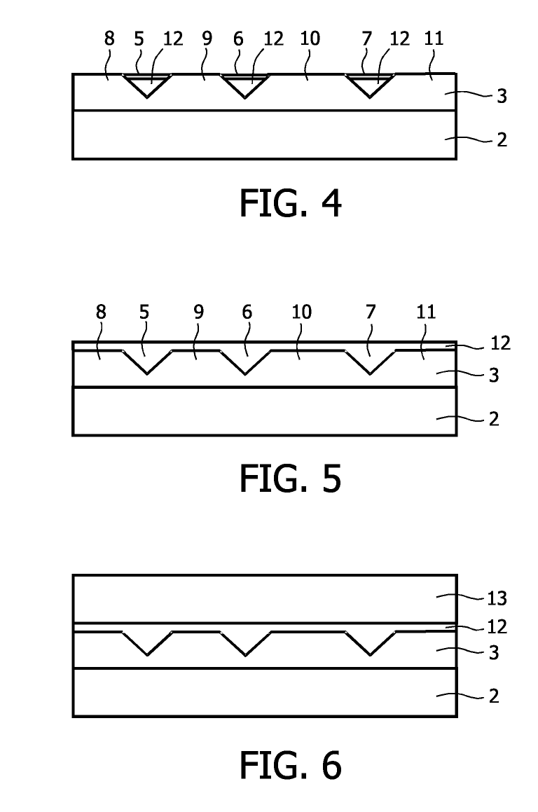

FIG. 4 shows the application of an intermediate layer in a first embodiment;

FIG. 5 shows the application of an intermediate layer in a second embodiment;

FIG. 6 shows the application of a substantially fluid composition as a precursor to a second substantially solid layer;

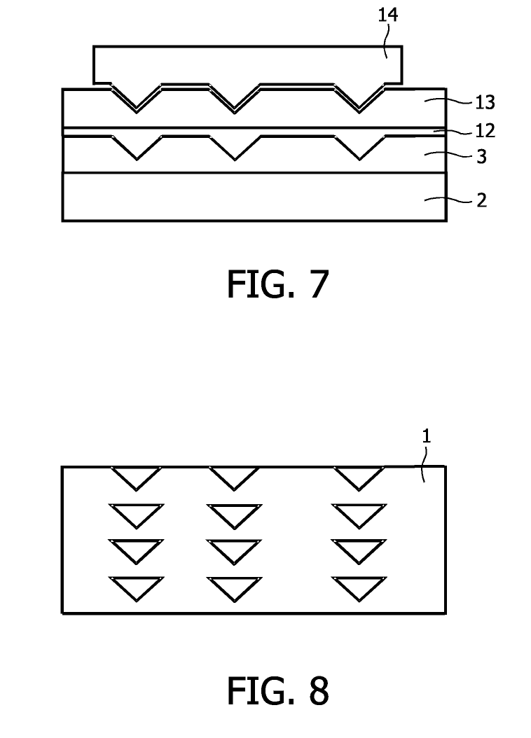

FIG. 7 shows the formation of a structure in the surface of the precursor to the second substantially solid layer; and

FIG. 8 shows a stack of layers including an example of a three-dimensional structure.

In the following, a method of manufacturing a stack 1 (FIG. 8) of layers to form a three-dimensional structure will be illustrated. The structure is three-dimensional in that it comprises features with a contour developing in directions parallel to the surface, as well as perpendicular to the surface (i.e. depthwise). In the example, the layers have substantially the same material composition, so as to bond more easily. In alternative variants, the components or their ratio may vary in the direction perpendicular to the surface.

In the illustrated embodiment, a substantially fluid composition is deposited on a substrate 2 to form a lower layer 3, or a precursor thereto (FIG. 1). Subsequently, a structure is formed in the lower layer 3 by means of a stamp 4. As is visible in FIG. 3, showing the stage after the stamp 4 has been withdrawn, the structure includes recessed parts 5 to 7 surrounded by raised parts 8 to 11.

The stamp 4, or at least the part of it facing the lower layer 3, is comprised of an elastically deformable material. In particular, the limit of elasticity lies at a value substantially higher than the adhesion force per unit area of contact of the stamp 4 with the material of the lower layer 3 when set to preserve the impressed structure. Thus, the stamp 4 retains an accurate negative imprint of the structure to be formed in the lower layer 3. It can therefore be used again. Advantageous materials for the stamp 4 include silicone compositions such as PDMS, or other elastomers.

In the stage shown in FIG. 2, the material forming the lower layer 3 is in one of a plastically deformable or fluid state. In the former case, the transition from the stage illustrated in FIG. 2 to that shown in FIG. 3 comprises only withdrawing the stamp 4. The lower layer 3 is processed prior to impressing the stamp 4 so as to allow the structure to be preserved when the stamp 4 is withdrawn, for example upon formation of the lower layer 3. In the latter case, the lower layer 3 is set with the stamp 4 impressed on it, so as to allow the structure to be preserved when the stamp 4 is withdrawn.

In one embodiment, the lower layer 3 is formed by applying a suspension of particles, for example ceramic or metallic particles. After application, the liquid medium in which the particles are suspended is drained through a porous substrate 2 and/or porous walls (not shown) projecting from the porous substrate 2. Thus, the stack 1 of layers is formed in a porous mould. Techniques such as those described in International patent application PHNL050216=ID697389 are applied to advantage in this embodiment. Drainage takes place in the stage shown in FIG. 2, with the stamp 4 floating on the suspension of particles. The stamp is withdrawn when the lower layer 3 has set, i.e. solidified, to an extent sufficient to preserve the structure after the stamp has been withdrawn. Further consolidation is carried out at a later stage, as will be explained. At the stage shown in FIG. 3, the lower layer 3 comprises a porous powder compact, in this embodiment.

The particles have a particle size distribution predominantly within the range of 0.01 to 25 μm, more preferably 0.01 to 2 μm. This contributes to a high packing density upon drying. Suitable particle materials include oxides, nitrides, carbides, silicides, borides, silicates, titanates, zirconates and mixtures thereof, as well as aluminium, barium, beryllium, boron, calcium, magnesium, lanthanum and other lanthanides, lead, silicon, tungsten, zirconium and mixtures thereof. It is preferred that the particles are of a material susceptible to sintering, i.e. having the property of coalescing under the influence of heat without actually liquefying. In favorable embodiments, a ceramic material transparent to light in the visible wavelengths is used, in order to produce an optical component. Examples of suitable ceramics for this purpose include Al₂O₃ and YAG. Other examples of materials include AlON, MgAl₂O₄, Y₂O₃, Si₂Al₆O₁₃, AlN, SiC, SiN, MgO, SiO₂, Li₂O and ZrO₂. In embodiments in which a liquid fraction of the suspension is drained, the liquid fraction generally comprises a mixture. It may, for example, include a dispersant and/or a binder.

In other embodiments than the one in which a liquid suspension medium is drained, the lower layer 3 is formed on a substrate with a relatively smooth upper surface, as opposed to being porous. This has the advantage that it is relatively easy to remove the lower layer 3, and layers formed on top of it. In an example of such an embodiment, the medium in which the particles are suspended is removed by evaporating it.

In another embodiment, particles such as those described above are suspended in a gel, or in a substantially fluid composition capable of forming a gel, in the stage shown in FIG. 1. Where a gel is applied, the lower layer 3 is preferably formed by doctor blading. Spin coating is a suitable technique where a fluid composition capable of forming a gel is applied. This enables the formation of a relatively thin and level lower layer 3. Moreover, the thickness of the lower layer 3 can be controlled relatively precisely with these techniques. The gel is plastically deformable. Because the gel is a semi-solid colloidal suspension or jelly of solid particles suspended in a liquid, it is sufficiently solid that the structure impressed by the stamp 4 is preserved when the stamp is withdrawn. A porous powder compact is obtainable by removing the medium in which the particles originally were suspended. In this manner, a substantially homogeneous porous layer with a well-defined structure at its surface is obtained.

In embodiments in which the substantially fluid composition capable of forming a gel is applied, the gel is formed in situ either prior to impressing the stamp 4 or whilst the stamp 4 is floating on the lower layer 3. In one variant, the gelling is triggered by the slow addition of a salt. In another variant, gelling is triggered by altering the acidity level. Gel formation can also occur due to reacting monomers present in the suspension or by means of stimulation by radiation of a UV curable resin that is present in the suspension. In the latter variant, a stamp 4 transparent to UV radiation is employed. The triggering of the gelling leads to slow aggregation of the particles suspended therein, as in the case of direct coagulation casting (DCC).

An example of an embodiment in which a substantially fluid composition is applied and gelling is triggered in the configuration shown in FIG. 2 is the following. To a 40 Vol % suspension of alpha aluminium (available under the name TM-DAR from Taimei Chemicals Company Ltd.), 1.0 mass % Al₂(OH)₅Cl is added. The alpha aluminium has a purity higher than 99.99%, a mean particle size of about 0.1 μm, and can achieve a near-theoretical density at sintering temperatures below 1570 K. The suspension is milled for twenty-four hours using aluminium milling beads. The acidity level of the suspension at that stage is pH=4. After twenty four hours of milling, 0.5 mass % of ethanol, 0.5 mass % of emulsion binder and 0.5 mass % of urea are added. An example of a suitable binder is available as Duramax B1014, an acrylic emulsion binder, from Rohm & Haas. All mass percentages are relative to the mass of the 40 vol % suspension. Ethanol is added to suppress foaming, and the binder is added to suppress cracking of the gel. The Al₂(OH)₅Cl—Urea system is responsible for the gelling of the suspension. The suspension is applied to the substrate 2. The stamp (made of Silicone in the example) is put on top of the suspension. The stamp 4 remains floating on the surface. Thus, the depth of the recessed parts 5 to 7 is determined. The need for a control system is obviated. When the suspension is stored at about 360 K, urea gradually decomposes into CO₂ and NH₃, leading to an increase in the pH value. This increase leads to a polymerization of Al₂(OH)₅Cl. Meanwhile, the aluminium particles start losing their surface charge as the pH value approaches the iso-electric point (IEP) of aluminium. This results in coagulation of the aluminium particles. The polymerization of Al₂(OH)₅Cland the coagulation together lead to gelling of the entire suspension within twenty-four hours. After the gel has been formed, the stamp 4 is removed from the gel interface, leaving an embossed gel surface, in which a structure including the recessed parts 5 to 7 is preserved. Other types of gel-forming procedures, known per se in the art, are employed in other embodiments.

In a next step, an intermediate composition 12 is applied so as at least partially to fill at least the recessed parts 5 to 7 of the structure on the surface of the lower layer 3. In the embodiment illustrated in FIG. 4, the recessed parts 5 to 7 are filled to a level at or below the level of the raised parts 8 to 11 surrounding them. In the embodiment illustrated in FIG. 5, the intermediate composition 12 also covers the exposed surface of the raised parts 8 to 11, to form a level layer. A substantially solid subsequent layer 13 (FIG. 6) is formed over the lower layer 3 after application of the intermediate composition 12. The embodiment illustrated in FIG. 4 is preferably applied where the intermediate composition 12 hampers bonding of the lower layer 3 and the substantially solid subsequent layer 13. Otherwise, the embodiment illustrated in FIG. 5 is applied, resulting in better-defined depth of the recessed parts 5 to 7 when covered by the subsequent layer 13. Such an embodiment is illustrated in FIGS. 6 and 7.

The intermediate composition 12 is impervious to a substantially fluid composition applied to form the subsequent layer 13. Application of the intermediate composition 12 serves both to seal the (possibly porous) lower layer 3 and prevent penetration of the fluid composition applied over it into the recessed parts 5 to 7. In fact, the intermediate composition 12 serves to level the surface of the lower layer 3 prior to application of a substantially fluid precursor of the subsequent layer 13. In combination with the gelling suspension described in detail above, suitable intermediate compositions are dissolved polymers and UV-curable polymers, for example acrylates or epoxides.

Any of the techniques described above with regard to the formation of the lower layer 3 can be used to form the subsequent layer 13. In each case a substantially fluid composition is applied over a surface and at least partially set. Where a gel is applied, the composition becomes substantially fluid under shear, induced, for example, by a doctor blade. It sets partly when the shear ceases, and further during heat treatment to remove solvents and/or gelling medium from the layer 13.

As shown in FIG. 7, a further stamp 14 is advantageously used to impress a second structure 15 on the subsequent layer 13. Again, the subsequent layer 13 is set prior to or after application of the further stamp 14, to an extent sufficient to preserve the second structure when the further stamp 14 is withdrawn. The entire process is repeated to form the stack 1 of layers. The stack 1 of layers is then dried, calcinated and sintered, leaving a three-dimensional body with a well-defined, preferably porous, structure.

In the process, the intermediate composition 12 decomposes by heat treatment. Where any of the layers in the stack comprise a powder compact, the intermediate composition 12 is preferably selected so as to burn out at a temperature below the temperature at which the powder compact is sintered. In other cases, the intermediate composition is washed or flushed out.

The techniques described above find application in the manufacture of ceramic components. Ceramics are, for example, good conductors of heat, good electrical insulators, and, in special cases, are also transparent. Advantageous use of these properties is made in the manufacture of light couplers and heat pipes, for example to cool integrated circuits or Light Emitting Diodes (LEDs). Other applications include the manufacture of stacked channels for micro-fluidic devices, as well as micro-sieves.

The obtained devices are novel and distinguishable from devices obtainable using known techniques. For example, the techniques described herein result in a layered device with well-defined features on a μm-scale. The layers coalesce due to the sintering. The resolution with which the features are defined is higher than attainable by means of stereo-lithography, due to the scattering of light in that technique. The resolution is also higher than that attainable by printing, due to the relatively high viscosity of the colloid suspensions used in that technique. Isolated voids can be included in the three-dimensional structure, “Negative” shapes are also attainable, by which is meant shapes that taper in the direction towards and perpendicular to the surface.

It should be noted that the above embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. Method of manufacturing a component having a three-dimensional structure in a surface region, including:
a step of forming a substantially solid layer (13) of material, which step comprises the steps of applying a substantially fluid composition over a surface, and
a step of removing an intermediate composition (12), impervious to at least a component of the substantially fluid composition and occupying at least part of the three-dimensional structure when the substantially fluid composition has at least partially set, characterized in that the step of forming the substantially solid layer (13) of material is preceded by the steps of
providing a structure including recessed parts (5 to 7) on a surface of a substantially solid further layer (3), and
applying the intermediate composition (12) so as at least partially to fill at least the recessed parts (5 to 7) of the structure on the surface of the substantially solid further layer (3).

2. Method according to claim 1, in that the step of providing the structure on the surface of the further layer (3) includes the step of impressing a stamp (4) including a negative imprint of at least part of the structure on a deformable precursor of the further layer (3), in that the deformable precursor of the further layer is processed so as to allow the structure to be preserved when the stamp (4) is withdrawn.

3. Method according to claim 1, in that the step of forming the substantially solid layer (13) of material includes the step of impressing a stamp (14), including a negative imprint of at least part of a structure, on a deformable precursor of the substantially solid layer (13), and setting the substantially fluid composition to an extent sufficient to enable the structure to be preserved when the stamp (14) is withdrawn.

4. Method according to claim 2, including impressing a stamp (4,14) comprising an elastic material, the negative imprint being provided in the elastic material.

5. Method according to claim 2, in that the deformable precursor is provided in the form of a gel.

6. Method according to claim 5, including providing the deformable precursor by applying a layer of a gelling suspension and triggering the gelling after application of the layer.

7. Method according to claim 1, in that at least one of the substantially fluid composition and a substantially fluid precursor of the substantially solid further layer (3) includes a suspension of particles, in that the method includes the step of removing material in which the particles are suspended after the step of forming a substantially solid layer of material.

8. Method according to claim 1, in that at least one of the substantially solid layer of material (13) and the substantially solid further layer (3) comprises particles susceptible to sintering, and in that the method includes the step of sintering the object comprising the substantially solid layer of material.

9. Method according to claim 1, in that the step of removing the intermediate composition includes subjecting the component comprising the substantially solid layer of material to a heat treatment.

10. Application of a method according to claim 1 in the manufacture of a ceramic component, preferably a ceramic optical component having a reflective and/or refractive structure.

11. Ceramic component, obtainable by means of a method according to claim 1.
